(19) United States
(12) Patent Application Publication
(10) Pub. No.: US 2022/0049966 A1
(43) Pub. Date: Feb. 17, 2022

(54) CONTROL APPARATUS, SERVICE FACILITY, SERVER APPARATUS, SYSTEM, AND CONTENT OUTPUT METHOD

(71) Applicant: Toyota Jidosha Kabushiki Kaisha, Toyota-shi Aichi-ken (JP)

(72) Inventors: Yuta Kodama, Toyota-shi Aichi-ken (JP); Hideo Hasegawa, Nagoya-shi Aichi-ken (JP); Rio Minagawa, Nagoya-shi Aichi-Ken (JP); Chris Risberg, Flower Mound, TX (US)

(21) Appl. No.: 17/399,372

(22) Filed: Aug. 11, 2021

(30) Foreign Application Priority Data
Aug. 11, 2020 (JP) 2020-136062

(51) Int. Cl. G01C 21/34; G06Q 50/30; G06K 9/00

(52) U.S. Cl. CPC G01C 21/3476; B60S 5/00; G06K 9/00624; G06Q 50/30

(57) ABSTRACT

A control apparatus includes a controller configured to acquire destination data indicating a destination to which a customer is heading with a vehicle that has stopped in front of a service facility, and perform control to output content that is customized according to the destination indicated by the destination data from an output device included in the service facility during a waiting time period for the customer that occurs while a service is provided by the service facility.

### CROSS-REFERENCE TO RELATED APPLICATION

This application claims priority to Japanese Patent Application No. 2020-136062, filed on Aug. 11, 2020, the entire contents of which are incorporated herein by reference.

### TECHNICAL FIELD

The present disclosure relates to a control apparatus, a service facility, a server apparatus, a system, and a content output method.

### BACKGROUND

Patent Literature (PTL) 1 discloses a refueling apparatus including a metering machine that has a built-in refueling mechanism such as a pump and a flow meter, and an advertising apparatus that is placed alongside the metering machine and has a strut and an advertising device provided on the top of the strut.

### CITATION LIST

### Patent Literature

PTL 1: JP H01-167098 A

### SUMMARY

Conventional refueling apparatuses often display advertisements intrusive to customers en route to destinations.

It would be helpful to provide content beneficial to a customer en route to a destination.

A control apparatus according to the present disclosure includes a controller configured to:

acquire destination data indicating a destination to which a customer is heading with a vehicle that has stopped in front of a service facility; and

perform control to output content that is customized according to the destination indicated by the destination data from an output device included in the service facility during a waiting time period for the customer that occurs while a service is provided by the service facility.

A server apparatus according to the present disclosure includes:

a controller configured to acquire destination data indicating a destination to which a customer is heading with a vehicle that has stopped in front of a service facility, and adjust, according to the destination indicated by the destination data, content to be output from an output device included in the service facility during a waiting time period for the customer that occurs while a service is provided by the service facility; and

a communication interface configured to transmit the content adjusted by the controller to a control apparatus included in the service facility.

A content output method according to the present disclosure includes:

adjusting, by a computer, content according to a destination to which a customer is heading with a vehicle that has stopped in front of a service facility; and

outputting the content from an output device included in the service facility during a waiting time period for the customer that occurs while a service is provided by the service facility.

According to the present disclosure, it is possible to provide content beneficial to a customer en route to a destination.

### BRIEF DESCRIPTION OF THE DRAWINGS

In the accompanying drawings:

FIG. 1 is a diagram illustrating a configuration of a system according to a first embodiment of the present disclosure;

FIG. 2 is a block diagram illustrating a configuration of a control apparatus according to the first embodiment of the present disclosure;

FIG. 3 is a block diagram illustrating a configuration of a server apparatus according to the first embodiment of the present disclosure;

FIG. 4 is a flowchart illustrating operations of the control apparatus according to the first embodiment of the present disclosure;

FIG. 5 is a flowchart illustrating operations of the server apparatus according to the first embodiment of the present disclosure;

FIG. 6 is a flowchart illustrating operations of the control apparatus according to a second embodiment of the present disclosure;

FIG. 7 is a flowchart illustrating operations of the server apparatus according to the second embodiment of the present disclosure;

FIG. 8 is a flowchart illustrating operations of the control apparatus according to a third embodiment of the present disclosure;

FIG. 9 is a flowchart illustrating operations of the server apparatus according to the third embodiment of the present disclosure;

FIG. 10 is a flowchart illustrating operations of the control apparatus according to a fourth embodiment of the present disclosure;

FIG. 11 is a flowchart illustrating operations of the server apparatus according to the fourth embodiment of the present disclosure;

FIG. 12 is a flowchart illustrating operations of the control apparatus according to a fifth embodiment of the present disclosure;

FIG. 13 is a flowchart illustrating operations of the server apparatus according to the fifth embodiment of the present disclosure; and

FIG. 14 is a flowchart illustrating operations of the control apparatus according to a sixth embodiment of the present disclosure.

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment, an embodiment of the present disclosure, will be described.

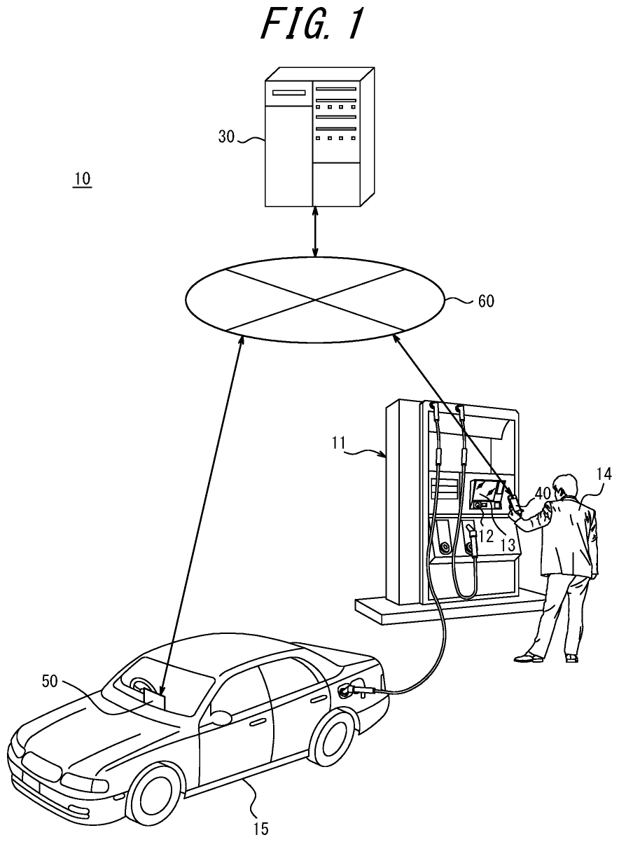

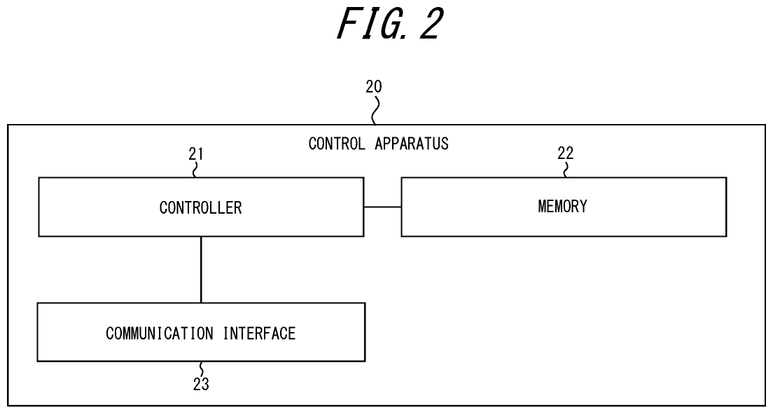

A configuration of a system 10 according to the present embodiment will be described with reference to FIGS. 1 and 2.

The system 10 according to the present embodiment includes at least one control apparatus 20 that is included in a service facility 11, at least one server apparatus 30, at least one first terminal apparatus 40, and at least one second terminal apparatus 50.

The control apparatus 20 may be installed outside the main unit of the service facility 11, but in the present embodiment, is built into the main unit of the service facility 11. The control apparatus 20 is, for example, a computer such as a microcomputer.

The service facility 11 is a facility that provides a service to a vehicle 15 that has stopped in front of the service facility 11, or to a customer 14 who is on board the vehicle 15 or has alighted from the vehicle 15. In the present embodiment, as the service, a service of supply of an energy source to the vehicle 15 is provided. The service of supply is a service of supplying an energy source such as gasoline, diesel fuel, electricity, or hydrogen to the vehicle 15. As a variation of the present embodiment, instead of the service of supply, another service such as a drive-through service that the customer 14 can receive while remaining in the vehicle 15 may be provided. The drive-through service is a service of providing the customer 14 with products such as fast food or coffee for which the customer 14 places an order while remaining in the vehicle 15.

The service facility 11 includes an input device 12 and an output device 13 in addition to the control apparatus 20. The input device 12 is, for example, a physical key, a capacitive key, a pointing device, a touch screen integrally provided with a display, an NFC reader, a two-dimensional code scanner, a camera, or a microphone. The term “NFC” is an abbreviation of near-field communication. The output device 13 is, for example, a display or a speaker. The display is, for example, an LCD or an organic EL display. The term “LCD” is an abbreviation of liquid crystal display. The term “EL” is an abbreviation of electro luminescence.

The server apparatus 30 is installed in a facility such as a data center. The server apparatus 30 is, for example, a server that belongs to a cloud computing system or another type of computing system.

The first terminal apparatus 40 is held by the customer 14. The first terminal apparatus 40 is, for example, a mobile device such as a mobile phone, a smartphone, or a tablet, or a PC. The term “PC” is an abbreviation of personal computer.

The second terminal apparatus 50 is mounted or installed in the vehicle 15. The second terminal apparatus 50 is, for example, an in-vehicle device such as a car navigation device, a mobile device such as a mobile phone, a smartphone, or a tablet, or a PC.

The vehicle 15 is, for example, any type of automobile such as a gasoline vehicle, a diesel vehicle, an HV, a PHV, an EV, or an FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. The vehicle 15 is driven by the customer 14 or a driver other than the customer 14 in the present embodiment, but the driving may be automated at any level. The automation level is, for example, any one of Level 1 to Level 5 according to the level classification defined by SAE. The name “SAE” is an abbreviation of Society of Automotive Engineers. The vehicle 15 may be a MaaS-dedicated vehicle. The term “MaaS” is an abbreviation of Mobility as a Service.

The control apparatus 20 can communicate with the server apparatus 30, the first terminal apparatus 40, and the second terminal apparatus 50 via a network 60. The server apparatus 30 can communicate with the first terminal apparatus 40 and the second terminal apparatus 50 via the network 60. The first terminal apparatus 40 may be able to communicate with the second terminal apparatus 50 via the network 60.

The network 60 includes the Internet, at least one WAN, at least one MAN, or a combination thereof. The term “WAN” is an abbreviation of wide area network. The term “MAN” is an abbreviation of metropolitan area network. The network 60 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIGS. 1 and 2.

In the present embodiment, the service facility 11 adjusts, by the control apparatus 20, content according to a destination to which the customer 14 is heading with the vehicle 15 that has stopped in front of the service facility 11. The service facility 11 outputs the content from the output device 13 during a waiting time period for the customer 14 that occurs while a service is provided by the service facility 11.

According to the present embodiment, it is possible to provide content beneficial to the customer 14 en route to the destination. For example, it is possible to output, to the customer 14, advertising content regarding a POI such as a restaurant, a hotel, a sightseeing spot, a park, an amusement park, a movie theater, a convenience store, a supermarket, a shopping mall, a department store, a pharmacy, a station, a parking lot, a hospital, a post office, or a bank in the vicinity of the destination. The term “POI” is an abbreviation of point of interest.

A configuration of the control apparatus 20 according to the present embodiment will be described with reference to FIG. 2.

The control apparatus 20 includes a controller 21, a memory 22, and a communication interface 23.

The controller 21 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, an interface compliant with a mobile communication standard such as LTE, the 4G standard, or the 5G standard, an interface compliant with a short-range wireless communication standard such as Bluetooth® (Bluetooth is a registered trademark in Japan, other countries, or both), or a LAN interface. The term “LTE” is an abbreviation of Long Term Evolution. The term “4G” is an abbreviation of 4th generation. The term “5G” is an abbreviation of 5th generation. The communication interface 23 receives data to be used for the operations of the control apparatus 20, and transmits data obtained by the operations of the control apparatus 20.

The functions of the control apparatus 20 are realized by execution of a control program according to the present embodiment by a processor serving as the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a dedicated circuit serving as the controller 21. That is, some or all of the functions of the control apparatus 20 may be realized by hardware.

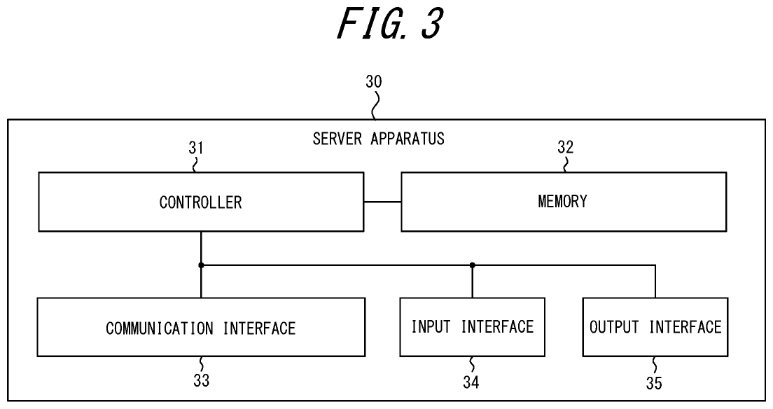

A configuration of the server apparatus 30 according to the present embodiment will be described with reference to FIG. 3.

The server apparatus 30 includes a controller 31, a memory 32, a communication interface 33, an input interface 34, and an output interface 35.

The controller 31 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 31 executes processes related to operations of the server apparatus 30 while controlling components of the server apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data to be used for the operations of the server apparatus 30 and data obtained by the operations of the server apparatus 30.

The communication interface 33 includes at least one interface for communication. The interface for communication is, for example, a LAN interface. The communication interface 33 receives data to be used for the operations of the server apparatus 30, and transmits data obtained by the operations of the server apparatus 30.

The input interface 34 includes at least one interface for input. The interface for input is, for example, a physical key, a capacitive key, a pointing device, a touch screen integrally provided with a display, a camera, or a microphone. The input interface 34 accepts an operation for inputting data to be used for the operations of the server apparatus 30. The input interface 34, instead of being included in the server apparatus 30, may be connected to the server apparatus 30 as an external input device. As the connection method, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface.

The output interface 35 includes at least one interface for output. The interface for output is, for example, a display or a speaker. The display is, for example, an LCD or an organic EL display. The output interface 35 outputs data obtained by the operations of the server apparatus 30. The output interface 35, instead of being included in the server apparatus 30, may be connected to the server apparatus 30 as an external output device. As the connection method, any technology such as USB, HDMI®, or Bluetooth® can be used.

The functions of the server apparatus 30 are realized by execution of a server program according to the present embodiment by a processor serving as the controller 31. That is, the functions of the server apparatus 30 are realized by software. The server program causes a computer to execute the operations of the server apparatus 30, thereby causing the computer to function as the server apparatus 30. That is, the computer executes the operations of the server apparatus 30 in accordance with the server program to thereby function as the server apparatus 30.

Some or all of the functions of the server apparatus 30 may be realized by a dedicated circuit serving as the controller 31. That is, some or all of the functions of the server apparatus 30 may be realized by hardware.

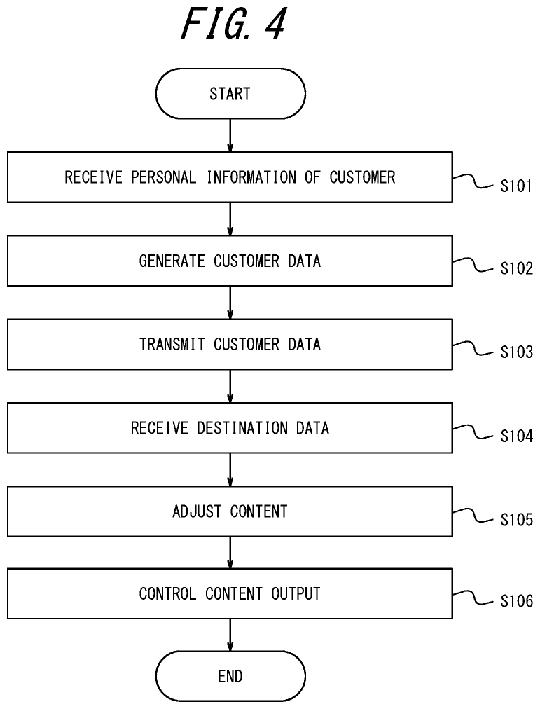

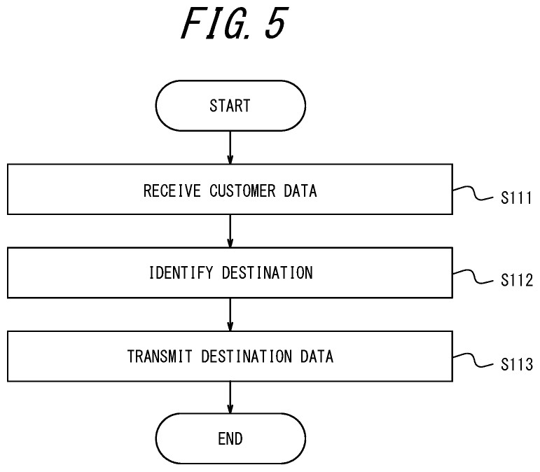

Operations of the system 10 according to the present embodiment will be described with reference to FIGS. 4 and 5. These operations correspond to a content output method according to the present embodiment. FIG. 4 illustrates operations of the control apparatus 20. FIG. 5 illustrates operations of the server apparatus 30.

The following operations start at or around a time when the vehicle 15 stops in front of the service facility 11 and a service begins to be provided by the service facility 11.

In step S101 of FIG. 4, the communication interface 23 of the control apparatus 20 receives personal information of the customer 14 that is input to the input device 12 included in the service facility 11, from the input device 12. The personal information includes identification information or biological information of the customer 14 in the present embodiment. The controller 21 of the control apparatus 20 acquires the personal information received by the communication interface 23.

The personal information may be input using any method. For example, identification information such as an ID or an email address of the customer 14 is read from a tag embedded in a mobile device that serves as the first terminal apparatus 40 using an NFC reader that serves as the input device 12. The term “ID” is an abbreviation of identifier. Alternatively, identification information such as an ID or an email address of the customer 14 is displayed in the form of a two-dimensional code on a screen of a mobile device that serves as the first terminal apparatus 40, and is read using a two-dimensional code scanner that serves as the input device 12. Alternatively, biological information such as the face, or the iris of an eye of the customer 14 is captured using a camera that serves as the input device 12. Alternatively, biological information such as the voice of the customer 14 is recorded using a microphone that serves as the input device 12.

In step S102 of FIG. 4, the controller 21 of the control apparatus 20 generates customer data D1 from the personal information acquired in step S101. The customer data D1 is data identifying the customer 14. The customer data D1 includes the personal information itself input to the input device 12, or data obtained by processing the personal information, such as a hash value of identification information or features of biological information.

In step S103 of FIG. 4, the controller 21 of the control apparatus 20 controls the communication interface 23 to transmit the customer data D1 generated in step S102. The communication interface 23 transmits the customer data D1 to the server apparatus 30.

In step S111 of FIG. 5, the communication interface 33 of the server apparatus 30 receives, from the control apparatus 20, the customer data D1 transmitted in step S103 of FIG. 4. The controller 31 of the server apparatus 30 acquires the customer data D1 received by the communication interface 33.

In step S112 of FIG. 5, the controller 31 of the server apparatus 30 identifies a destination to which the customer 14 is heading, using the customer data D1 acquired in step S111.

In the present embodiment, the server apparatus 30 manages the destination in association with the customer 14. Specifically, the server apparatus 30 registers in advance, in a database built in the memory 32 or external storage, personal information of each of two or more users, including the customer 14, and a destination to which each user is heading, associating each user with the destination. The controller 31 of the server apparatus 30 identifies the destination to which the customer 14 is heading by searching the database using the personal information included in the customer data D1 as a key. Alternatively, the server apparatus 30 registers in advance, in the database, data obtained by processing the personal information of each user, such as a hash value of identification information of each user or features of biological information of each user, and the destination to which each user is heading, associating the data with the destination. The controller 31 identifies the destination to which the customer 14 is heading by searching the database using the data obtained by processing the personal information, included in the customer data D1, as a key.

In step S113 of FIG. 5, the controller 31 of the server apparatus 30 controls the communication interface 33 to transmit destination data D2. The destination data D2 is data indicating the destination identified in step S112. The communication interface 33 transmits the destination data D2 to the control apparatus 20.

In step S104 of FIG. 4, the communication interface 23 of the control apparatus 20 receives, from the server apparatus 30, the destination data D2 transmitted in step S113 of FIG. 5 as a response to the customer data D1 transmitted in step S103. The controller 21 of the control apparatus 20 acquires the destination data D2 received by the communication interface 23.

In step S105 of FIG. 4, the controller 21 of the control apparatus 20 adjusts content according to the destination that is indicated by the destination data D2 acquired in step S104. This content may be any content, but is advertising content in the present embodiment. For example, the controller 21 acquires, from the memory 22 or external storage, advertising content regarding a POI such as a restaurant, a hotel, a sightseeing spot, a park, an amusement park, a movie theater, a convenience store, a supermarket, a shopping mall, a department store, a pharmacy, a station, a parking lot, a hospital, a post office, or a bank in the vicinity of the destination indicated by the destination data D2. The controller 21 edits the acquired advertising content to generate content for output.

In step S106 of FIG. 4, the controller 21 of the control apparatus 20 performs control to output the content adjusted in step S105 from the output device 13 included in the service facility 11 during a waiting time period for the customer 14 that occurs while the service is provided by the service facility 11. The waiting time period is, in the present embodiment, a time period until supply of an energy source is completed, but for example, if a drive-through service is provided instead of a service of supply, then is a time period until ordered products are provided.

The content may be output using any method. For example, the advertising content regarding a POI is displayed on a screen of a display serving as the output device 13. Alternatively, the advertising content regarding a POI is output as audio from a speaker serving as the output device 13.

As described above, in the present embodiment, the controller 21 of the control apparatus 20 acquires destination data D2 indicating a destination to which the customer 14 is heading with the vehicle 15 that has stopped in front of the service facility 11. The controller 21 performs control to output content that is customized according to the destination indicated by the destination data D2 from the output device 13 included in the service facility 11 during a waiting time period for the customer 14 that occurs while a service is provided by the service facility 11.

According to the present embodiment, it is possible to provide content beneficial to the customer 14 en route to the destination. As a result, the waiting time period for the customer 14 is expected to turn into a meaningful time period.

As a variation of the first embodiment, the content may be adjusted according to not only the destination to which the customer 14 is heading but also an attribute of the customer 14. A second embodiment, such a variation, will be described.

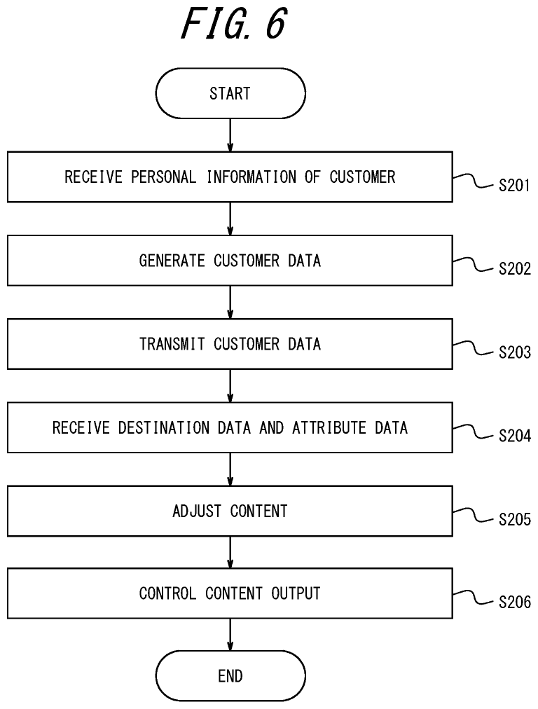

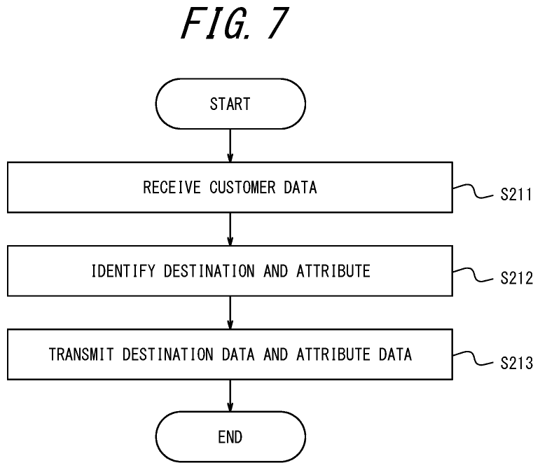

Operations of the system 10 according to the present embodiment will be described with reference to FIGS. 6 and 7. These operations correspond to a content output method according to the present embodiment. FIG. 6 illustrates operations of the control apparatus 20. FIG. 7 illustrates operations of the server apparatus 30.

The processes from step S201 to step S203 of FIG. 6 are the same as the processes from step S101 to step S103 of FIG. 4, and thus descriptions thereof are omitted.

The process in step S211 of FIG. 7 is the same as the process in step S111 of FIG. 5, and thus a description thereof is omitted.

In step S212 of FIG. 7, the controller 31 of the server apparatus 30 identifies a destination to which the customer 14 is heading and an attribute of the customer 14, using the customer data D1 acquired in step S211. The attribute includes, for example, the gender, the age, the family structure, the place of residence, the hometown, the occupation, the educational background, hobbies, preferences, or any combination thereof of the customer 14.

In the present embodiment, the server apparatus 30 manages the attribute in association with the customer 14. Specifically, the server apparatus 30 registers in advance, in a database built in the memory 32 or external storage, personal information of each of two or more users, including the customer 14, and an attribute of each user, associating each user with the attribute. The controller 31 of the server apparatus 30 identifies the attribute of the customer 14 by searching the database using the personal information included in the customer data D1 as a key. Alternatively, the server apparatus 30 registers in advance, in the database, data obtained by processing the personal information of each user, such as a hash value of identification information of each user or features of biological information of each user, and the attribute of each user, associating the data with the attribute. The controller 31 identifies the attribute of the customer 14 by searching the database using the data obtained by processing the personal information, included in the customer data D1, as a key. The database for managing attributes may be integrated with the database for managing destinations.

In step S213 of FIG. 7, the controller 31 of the server apparatus 30 controls the communication interface 33 to transmit destination data D2 and attribute data D3. The attribute data D3 is data indicating the attribute identified in step S212. The communication interface 33 transmits the destination data D2 and the attribute data D3 to the control apparatus 20.

In step S204 of FIG. 6, the communication interface 23 of the control apparatus 20 receives, from the server apparatus 30, the destination data D2 and the attribute data D3 transmitted in step S213 of FIG. 7 as a response to the customer data D1 transmitted in step S203. The controller 21 of the control apparatus 20 acquires the destination data D2 and the attribute data D3 received by the communication interface 23.

In step S205 of FIG. 6, the controller 21 of the control apparatus 20 adjusts content according to the destination that is indicated by the destination data D2 acquired in step S204, and the attribute that is indicated by the attribute data D3 acquired in step S204. For example, the controller 21 acquires, from the memory 22 or external storage, advertising content regarding a POI that is in the vicinity of the destination indicated by the destination data D2 and popular with persons who each have the attribute indicated by the attribute data D3. The controller 21 edits the acquired advertising content to generate content for output.

The process in step S206 of FIG. 6 is the same as the process in step S106 of FIG. 4, and thus a description thereof is omitted.

As described above, in the present embodiment, the controller 21 of the control apparatus 20 further acquires attribute data D3 indicating an attribute of the customer 14. The controller 21 adjusts the content according to the attribute indicated by the attribute data D3.

According to the present embodiment, it is possible to provide content more beneficial to the customer 14 en route to the destination. As a result, the waiting time period for the customer 14 is expected to turn into a more meaningful time period.

As another variation of the first embodiment, instead of the destination being managed in association with the customer 14, the destination may be managed in association with the vehicle 15. A third embodiment, such a variation, will be described.

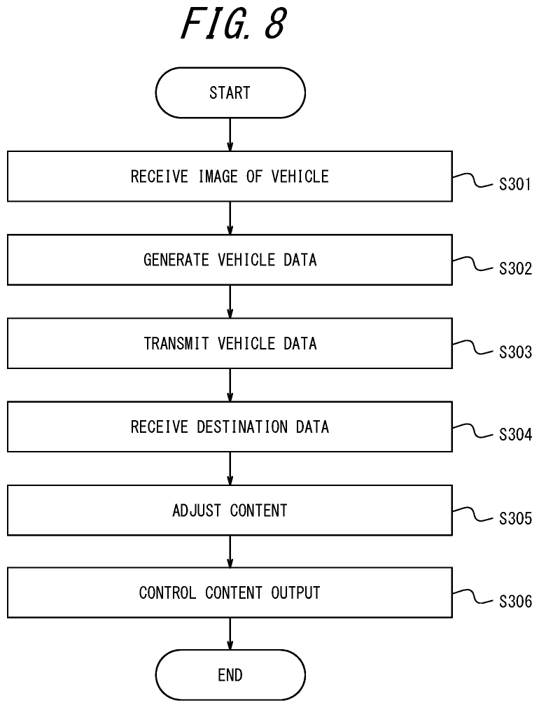

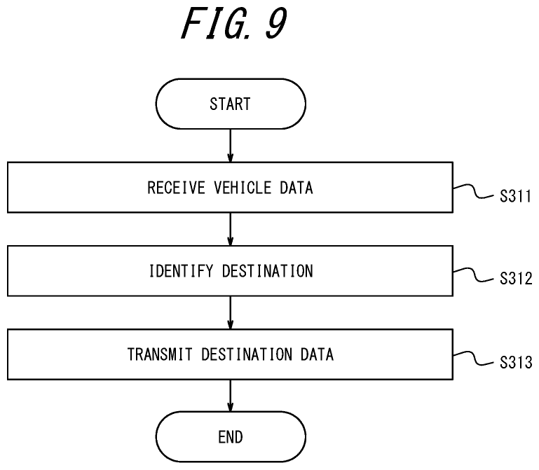

Operations of the system 10 according to the present embodiment will be described with reference to FIGS. 8 and 9. These operations correspond to a content output method according to the present embodiment. FIG. 8 illustrates operations of the control apparatus 20. FIG. 9 illustrates operations of the server apparatus 30.

The following operations start at or around a time when the vehicle 15 stops in front of the service facility 11 and a service begins to be provided by the service facility 11.

In step S301 of FIG. 8, the communication interface 23 of the control apparatus 20 receives an image of the vehicle 15 that is captured using a camera that serves as the input device 12 included in the service facility 11, from the camera. The image of the vehicle 15 includes, in the present embodiment, an image of the license plate on which the registration number of the vehicle 15 is printed. The controller 21 of the control apparatus 20 acquires the image received by the communication interface 23.

In step S302 of FIG. 8, the controller 21 of the control apparatus 20 generates vehicle data D4 from the image acquired in step S301. The vehicle data D4 is data identifying the vehicle 15. The vehicle data D4 is the image itself captured using the camera, or data indicating the registration number of the vehicle 15 identified by analyzing the image.

In step S303 of FIG. 8, the controller 21 of the control apparatus 20 controls the communication interface 23 to transmit the vehicle data D4 generated in step S302. The communication interface 23 transmits the vehicle data D4 to the server apparatus 30.

In step S311 of FIG. 9, the communication interface 33 of the server apparatus 30 receives, from the control apparatus 20, the vehicle data D4 transmitted in step S303 of FIG. 8. The controller 31 of the server apparatus 30 acquires the vehicle data D4 received by the communication interface 33.

In step S312 of FIG. 9, the controller 31 of the server apparatus 30 identifies a destination to which the customer 14 is heading, using the vehicle data D4 acquired in step S311.

In the present embodiment, the server apparatus 30 manages the destination in association with the vehicle 15. Specifically, the server apparatus 30 registers in advance, in a database built in the memory 32 or external storage, the registration number of each of the vehicle 15 and other vehicles, and a destination to which a corresponding user is heading with each vehicle, associating the registration number with the destination. The controller 31 of the server apparatus 30 analyzes the image of the license plate of the vehicle 15 included in the vehicle data D4 to identify the registration number of the vehicle 15. The controller 31 identifies the destination to which the customer 14 is heading by searching the database using the identified registration number as a key. Alternatively, the controller 31 identifies the destination to which the customer 14 is heading by searching the database using the registration number indicated by the vehicle data D4 as a key.

In step S313 of FIG. 9, the controller 31 of the server apparatus 30 controls the communication interface 33 to transmit destination data D2. The destination data D2 is data indicating the destination identified in step S312. The communication interface 33 transmits the destination data D2 to the control apparatus 20.

In step S304 of FIG. 8, the communication interface 23 of the control apparatus 20 receives, from the server apparatus 30, the destination data D2 transmitted in step S313 of FIG. 9 as a response to the vehicle data D4 transmitted in step S303. The controller 21 of the control apparatus 20 acquires the destination data D2 received by the communication interface 23.

The processes in step S305 and step S306 of FIG. 8 are the same as the processes in step S105 and step S106 of FIG. 4, and thus descriptions thereof are omitted.

As another variation of the first embodiment, the content may be adjusted by the server apparatus 30, instead of being adjusted by the control apparatus 20. A fourth embodiment, such a variation, will be described.

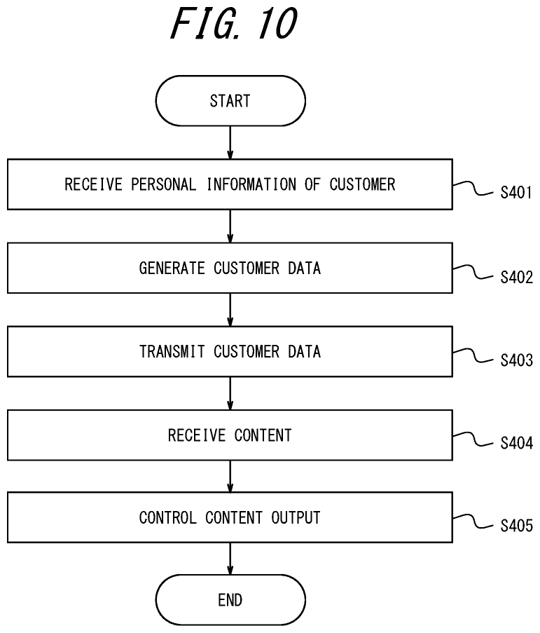

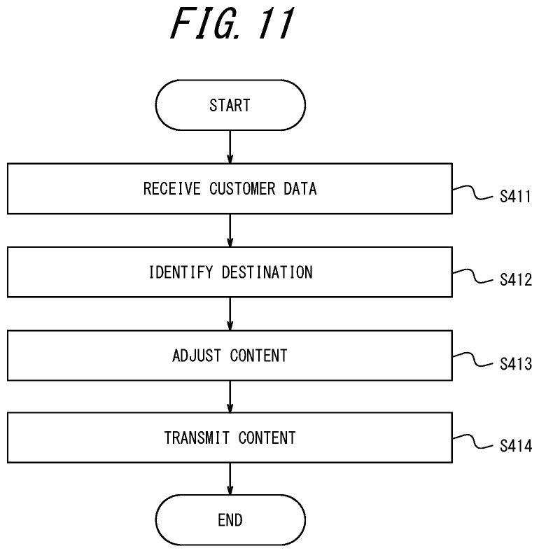

Operations of the system 10 according to the present embodiment will be described with reference to FIGS. 10 and 11. These operations correspond to a content output method according to the present embodiment. FIG. 10 illustrates operations of the control apparatus 20. FIG. 11 illustrates operations of the server apparatus 30.

The processes from step S401 to step S403 of FIG. 10 are the same as the processes from step S101 to step S103 of FIG. 4, and thus descriptions thereof are omitted.

The processes in step S411 and step S412 of FIG. 11 are the same as the processes in step S111 and step S112 of FIG. 5, and thus descriptions thereof are omitted.

In step S413 of FIG. 11, the controller 31 of the server apparatus 30 acquires destination data D2. The destination data D2 is data indicating the destination identified in step S412. The controller 31 adjusts content according to the destination indicated by the acquired destination data D2. For example, the controller 31 acquires, from the memory 32 or external storage, advertising content regarding a POI such as a restaurant, a hotel, a sightseeing spot, a park, an amusement park, a movie theater, a convenience store, a supermarket, a shopping mall, a department store, a pharmacy, a station, a parking lot, a hospital, a post office, or a bank in the vicinity of the destination indicated by the destination data D2. The controller 31 edits the acquired advertising content to generate content for output.

In step S414 of FIG. 11, the controller 31 of the server apparatus 30 controls the communication interface 33 to transmit the content adjusted in step S413. The communication interface 33 transmits the content to the control apparatus 20.

In step S404 of FIG. 10, the communication interface 23 of the control apparatus 20 receives, from the server apparatus 30, the content transmitted in step S414 of FIG. 11. The controller 21 of the control apparatus 20 acquires the content received by the communication interface 23.

In step S405 of FIG. 10, the controller 21 of the control apparatus 20 performs control to output the content acquired in step S404 from the output device 13 included in the service facility 11 during a waiting time period for the customer 14 that occurs while the service is provided by the service facility 11. The content may be completely downloaded in step S404 and then be output, or may be output in a streaming fashion.

As described above, in the present embodiment, the controller 31 of the server apparatus 30 acquires destination data D2 indicating a destination to which the customer 14 is heading with the vehicle 15 that has stopped in front of the service facility 11. The controller 31 adjusts, according to the destination indicated by the destination data D2, content to be output from the output device 13 included in the service facility 11 during a waiting time period for the customer 14 that occurs while a service is provided by the service facility 11. The communication interface 33 of the server apparatus 30 transmits the content adjusted by the controller 31 to the control apparatus 20 included in the service facility 11.

According to the present embodiment, the content can be adjusted in an environment such as a cloud environment, with higher performance, higher reliability, and lower costs than an on-premise environment such as the service facility 11.

As another variation of the first embodiment, when the vehicle 15 stops in front of the service facility 11, the destination data D2 may be transmitted from the server apparatus 30 to the control apparatus 20 without any data being transmitted from the control apparatus 20 to the server apparatus 30. A fifth embodiment, such a variation, will be described.

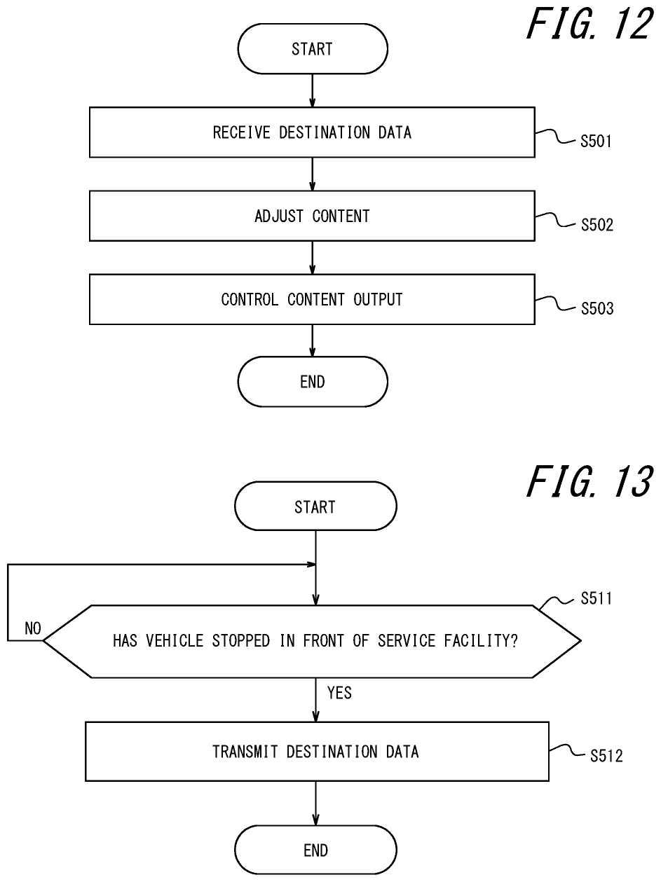

Operations of the system 10 according to the present embodiment will be described with reference to FIGS. 12 and 13. These operations correspond to a content output method according to the present embodiment. FIG. 12 illustrates operations of the control apparatus 20. FIG. 13 illustrates operations of the server apparatus 30.

In step S511 of FIG. 13, the controller 31 of the server apparatus 30 monitors the position of the vehicle 15, and determines whether the vehicle 15 has stopped in front of the service facility 11. If the vehicle 15 has stopped in front of the service facility 11, the process in step S512 is performed. If the vehicle 15 has not stopped in front of the service facility 11, the process in step S511 is performed again.

The position of the vehicle 15 may be monitored in any procedure, but in the present embodiment, is monitored in the following procedure.

The communication interface 33 of the server apparatus 30 receives positional data D5 from the second terminal apparatus 50. The positional data D5 is data indicating the position of the vehicle 15. Specifically, the positional data D5 is data indicating a position measured by a GNSS receiver embedded in or connected to the second terminal apparatus 50. The term “GNSS” is an abbreviation of global navigation satellite system. GNSS is, for example, GPS, QZSS, GLONASS, Galileo, or any combination thereof. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The controller 31 of the server apparatus 30 acquires the positional data D5 received by the communication interface 33. The controller 31 of the server apparatus 30 determines, with reference to map data D6, whether the position indicated by the acquired positional data D5 is within a certain range from the position of the service facility 11. The map data D6 may be stored in advance in the memory 32 of the server apparatus 30, or may be accumulated in an external system such as an Internet-based GIS. The term “GIS” is an abbreviation of geographic information system. The controller 31 determines that the vehicle 15 has stopped in front of the service facility 11 if the position indicated by the positional data D5 is within the certain range from the position of the service facility 11. The controller 31 determines that the vehicle 15 has not stopped in front of the service facility 11 if the position indicated by the positional data D5 is not within the certain range from the position of the service facility 11.

In step S512 of FIG. 13, the controller 31 of the server apparatus 30 acquires destination data D2 stored in advance in the memory 32 or external storage. The destination data D2 is data indicating a destination to which the customer 14 is heading with the vehicle 15. The controller 31 controls the communication interface 33 to transmit the acquired destination data D2. The communication interface 33 transmits the destination data D2 to the control apparatus 20.

In step S501 of FIG. 12, the communication interface 23 of the control apparatus 20 receives, from the server apparatus 30, the destination data D2 transmitted in step S512 of FIG. 13. The controller 21 of the control apparatus 20 acquires the destination data D2 received by the communication interface 23.

The processes in step S502 and step S503 of FIG. 12 are the same as the processes in step S105 and step S106 of FIG. 4, and thus descriptions thereof are omitted.

As described above, in the present embodiment, the communication interface 23 of the control apparatus 20 receives destination data D2 from the server apparatus 30 when the vehicle 15 stops in front of the service facility 11.

According to the present embodiment, the processing procedure executed at the service facility 11 can be simplified.

As a variation of the fifth embodiment, the destination data D2 may be transmitted from the second terminal apparatus 50 mounted or installed in the vehicle 15 to the control apparatus 20, instead of being transmitted from the server apparatus 30 to the control apparatus 20. In such a variation, the processes in step S511 and step S512 of FIG. 13 are omitted. In step S501 of FIG. 12, the communication interface 23 of the control apparatus 20 receives the destination data D2 from the second terminal apparatus 50. Specifically, the communication interface 23 receives the destination data D2 from the second terminal apparatus 50 via the network 60. Alternatively, the communication interface 23 receives the destination data D2 directly from the second terminal apparatus 50 by a short-range wireless communication such as Bluetooth®.

According to this variation, the server apparatus 30 is not required.

As another variation of the fifth embodiment, the destination data D2 may be transmitted from the first terminal apparatus 40 held by the customer 14 to the control apparatus 20, instead of being transmitted from the server apparatus 30 to the control apparatus 20. In such a variation, the processes in step S511 and step S512 of FIG. 13 are omitted. In step S501 of FIG. 12, the communication interface 23 of the control apparatus 20 receives the destination data D2 from the first terminal apparatus 40. Specifically, the communication interface 23 receives the destination data D2 from the first terminal apparatus 40 via the network 60 or the input device 12 such as an NFC reader or a two-dimensional code scanner. Alternatively, the communication interface 23 receives the destination data D2 directly from the first terminal apparatus 40 by a short-range wireless communication such as Bluetooth®.

According to this variation, the server apparatus 30 is not required.

As a further variation of this variation, the content may be adjusted according to not only the destination to which the customer 14 is heading but also an attribute of the customer 14, as in the second embodiment. A sixth embodiment, such a variation, will be described.

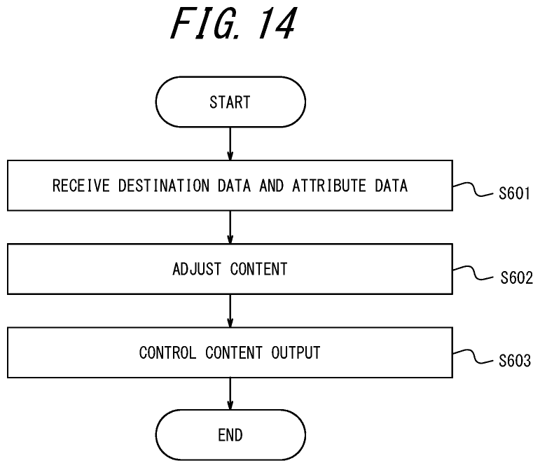

Operations of the system 10 according to the present embodiment will be described with reference to FIG. 14. These operations correspond to a content output method according to the present embodiment. FIG. 14 illustrates operations of the control apparatus 20.

In step S601 of FIG. 14, the communication interface 23 of the control apparatus 20 receives the destination data D2 and attribute data D3 from the first terminal apparatus 40. Specifically, the communication interface 23 receives the destination data D2 and the attribute data D3 from the first terminal apparatus 40 via the network 60 or the input device 12 such as an NFC reader or a two-dimensional code scanner. Alternatively, the communication interface 23 receives the destination data D2 and the attribute data D3 directly from the first terminal apparatus 40 by a short-range wireless communication such as Bluetooth®. The controller 21 of the control apparatus 20 acquires the destination data D2 and the attribute data D3 received by the communication interface 23. The processes in step S602 and step S603 of FIG. 14 are the same as the processes in step S205 and step S206 of FIG. 6, and thus descriptions thereof are omitted.

According to the present embodiment, as in the second embodiment, it is possible to provide content more beneficial to the customer 14 en route to the destination. As a result, the waiting time period for the customer 14 is expected to turn into a more meaningful time period.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

For example, the changes from the first embodiment to the fourth embodiment may be applied to the fifth embodiment. That is, when it is determined in step S511 of FIG. 13 that the vehicle 15 has stopped in front of the service facility 11, the processes in step S413 and step S414 of FIG. 11 may be performed instead of the process in step S512 of FIG. 13. Then, the processes in step S404 and step S405 of FIG. 10 may be performed instead of the processes from step S501 to step S503 of FIG. 12.

In this variation, the controller 31 of the server apparatus 30 monitors the position of the vehicle 15, and controls the communication interface 33 to transmit the content when the vehicle 15 stops in front of the service facility 11.

According to this variation, the processing procedure executed at the service facility 11 can be further simplified.

1. A control apparatus comprising a controller configured to:
acquire destination data indicating a destination to which a customer is heading with a vehicle that has stopped in front of a service facility; and
perform control to output content that is customized according to the destination indicated by the destination data from an output device included in the service facility during a waiting time period for the customer that occurs while a service is provided by the service facility.

2. The control apparatus according to claim 1, further comprising a communication interface configured to receive the destination data,
wherein the controller is configured to acquire the destination data received by the communication interface.

3. The control apparatus according to claim 2, wherein the communication interface is configured to receive the destination data from a server apparatus configured to manage the destination.

4. The control apparatus according to claim 3, wherein
the server apparatus is configured to manage the destination in association with the customer,
the controller is configured to generate customer data identifying the customer from personal information of the customer that is input to an input device included in the service facility, and
the communication interface is configured to transmit the customer data generated by the controller to the server apparatus, and receive the destination data as a response to the transmitted customer data.

5. The control apparatus according to claim 3, wherein
the server apparatus is configured to manage the destination in association with the vehicle,
the controller is configured to generate vehicle data identifying the vehicle from an image of the vehicle that is captured using a camera included in the service facility, and
the communication interface is configured to transmit the vehicle data generated by the controller to the server apparatus, and receive the destination data as a response to the transmitted vehicle data.

6. The control apparatus according to claim 3, wherein the communication interface is configured to receive the destination data from the server apparatus when the vehicle stops in front of the service facility.

7. The control apparatus according to claim 2, wherein the communication interface is configured to receive the destination data from a terminal apparatus mounted or installed in the vehicle.

8. The control apparatus according to claim 2, wherein the communication interface is configured to receive the destination data from a terminal apparatus held by the customer.

9. The control apparatus according to claim 1, wherein the controller is configured to further acquire attribute data indicating an attribute of the customer, and adjust the content according to the attribute indicated by the attribute data.

10. The control apparatus according to claim 9, further comprising a communication interface configured to receive the attribute data,
wherein the controller is configured to acquire the attribute data received by the communication interface.

11. The control apparatus according to claim 10, wherein the communication interface is configured to receive the attribute data from a server apparatus configured to manage the attribute in association with the customer.

12. The control apparatus according to claim 11, wherein
the controller is configured to generate customer data identifying the customer from personal information of the customer that is input to an input device included in the service facility, and
the communication interface is configured to transmit the customer data generated by the controller to the server apparatus, and receive the attribute data as a response to the transmitted customer data.

13. The control apparatus according to claim 10, wherein the communication interface is configured to receive the attribute data from a terminal apparatus held by the customer.

14. A service facility comprising the control apparatus according to claim 1.

15. The service facility according to claim 14, wherein, as the service, a service of supply of an energy source to the vehicle is provided.

16. The service facility according to claim 14, wherein, as the service, a drive-through service that the customer can receive while remaining in the vehicle is provided.

17. A server apparatus comprising:
a controller configured to acquire destination data indicating a destination to which a customer is heading with a vehicle that has stopped in front of a service facility, and adjust, according to the destination indicated by the destination data, content to be output from an output device included in the service facility during a waiting time period for the customer that occurs while a service is provided by the service facility; and
a communication interface configured to transmit the content adjusted by the controller to a control apparatus included in the service facility.

18. The server apparatus according to claim 17, wherein the controller is configured to monitor a position of the vehicle, and control the communication interface to transmit the content when the vehicle stops in front of the service facility.

19. A system comprising:
the server apparatus according to claim 17; and
the control apparatus.

20. A content output method comprising:
adjusting, by a computer, content according to a destination to which a customer is heading with a vehicle that has stopped in front of a service facility; and
outputting the content from an output device included in the service facility during a waiting time period for the customer that occurs while a service is provided by the service facility.
